(19) United States
(12) Patent Application Publication
(10) Pub. No.: US 2002/0189894 A1
(43) Pub. Date: Dec. 19, 2002

(54) Aural feedback apparatus

(75) Inventors: Diane L. Davis, Dallas, TX (US); Michael G. Davis, Dallas, TX (US)

Correspondence Address: Michael L. Diaz, Michael L. Diaz, P.C., Suite 200, 555 Republic Drive, Plano, TX, 75074, US

(73) Assignee: DIKAT, L.L.C.

(21) Appl. No.: 09/880,401

(22) Filed: Jun. 13, 2001

(51) Int. Cl. H04R 25/00

(52) U.S. Cl. 181/128; 181/126; 181/21

(57) ABSTRACT

A feedback device providing immediate feedback to a user. The feedback device includes a main hollow tubular body having a first transmitter end and an opposite second receiver end. The feedback device is “C” shaped and sized to comfortably allow the user to hold the transmitter end close to his mouth while simultaneously positioning the receiver end close to the ear of the user. The user speaks into the transmitter end. The sounds emitted by the user are amplified within the main tubular body and directed through the receiver end to the ear of the user. The feedback device provides immediate feedback for all sounds produced by the user. The feedback device may be used to enhance the reading and speaking ability of the user.

### BACKGROUND OF THE INVENTION

1. Technical Field of the Invention

This invention relates to devices providing verbal assistance to users, and more particularly, to an apparatus which reinforces verbal communication by providing immediate feedback to a user of the apparatus.

2. Description of Related Art

Poor verbal communication skills is a common problem among both children and adults. Specifically, individuals sometimes have difficulty correctly pronouncing various words. For children, this problem can be seen in reading out loud to others. For example, children may have difficulty properly pronouncing various words. It is quite common for the child to verbalize one sound or word, while believing the sound or word was pronounced in a different fashion. Thus, the child verbalizes one word in an incorrect fashion, without realizing his mistake. The verbalizations of the child may not be correctly heard by the child because of various reasons, such as background noise or the simple fact that the child is too intently focused on reading the word. In addition, if a child speaks another language and is attempting to pronounce words from another language, the problem of reading out loud becomes more acute.

Verbalization problems can also be seen with adults. For example, adults learning a foreign language also encounter difficulties in correctly pronouncing various words. In a similar fashion as with children experiencing reading difficulties, the adult may also believe he is pronouncing the word correctly, however, in reality the word is being incorrectly pronounced. Therefore, a misconception develops between what is actually spoken and what the adult believes is spoken. This misconception is again due to the individual not receiving immediate feedback on the individual's verbalization of various words.

Existing devices and systems have been used by schools to provide some type of feedback on an individual's verbalizations. For example, teachers have oftentimes tape recorded a student as he is reading out loud. The teacher then replays the recording for the student's review. While this method provides some feedback to the student, the student does not receive the feedback in a timely fashion. The lapse of time from when the student speaks, until the recording is replayed diminishes the effectiveness of the feedback. It is well known that individuals are better able to respond to feedback when presented the feedback immediately afterwards. Thus, if a student is having difficulties reading, feedback presented in a delayed manner may not be particularly helpful. An apparatus is needed which provides immediate feedback to the individual.

There is no existing device which disclosures or suggests an apparatus which provides immediate verbal feedback to a person speaking out loud. It is an object of the present invention to provide such an apparatus.

### SUMMARY OF THE INVENTION

In one aspect, the present invention is a verbal feedback device for enhancing the speaking ability of a user. The device includes a main hollow body, a receiver end affixed to a first end of the main hollow body, and a transmitter end affixed to a second opposite end of the main hollow body. The user positions the transmitter end near the mouth of the user and the receiver end near the ear of the user. The user then speaks into the transmitter end sending sounds through the main body to the receiver end and to the ear of the user. Thus, immediate feedback of the sent sounds are provided to the user.

In another aspect, the present invention is a verbal feedback device for enhancing the speaking ability of a user. The device includes a main hollow body, and a curved receiver end affixed to a first end of the main hollow body. The receiver end has a first planar surface with a first plurality of openings. In addition, the device includes a curved transmitter end affixed to a second opposite end of the main hollow body. The transmitter end has a second planar surface with a second plurality of openings. The user positions the main hollow body parallel to a face of the user. The transmitter end is placed near the mouth of the user and the receiver end near the ear of the user. The user then speaks into the transmitter end sending sounds through the main body to the receiver end and to the ear of the user to provide immediate feedback of the sent sounds to the user.

In still another aspect, the present invention is a verbal feedback device for enhancing the speaking ability of a user. The device includes a main tubular body having a hollow chamber, a receiver end affixed to a first end of the main hollow body, and a transmitter end affixed to a second opposite end of the main hollow body. The user positions the transmitter end near the mouth of the user and the receiver end near the ear of the user. The user speaks into the transmitter end sending sounds through the main body into the hollow chamber. The hollow chamber amplifies the sent sounds and directs the sounds to the receiver end and to the ear of the user to provide immediate feedback of the sent sounds to the user.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front perspective view of a user and the feedback device in the preferred embodiment of the present invention;

FIG. 2 is a side view of the feedback device of FIG. 1;

FIG. 3 is a top view of the receiver end of the feedback device of FIG. 1; and

FIG. 4 is a top view of the transmitter end of the feedback device of FIG. 1.

### DETAILED DESCRIPTION OF EMBODIMENTS

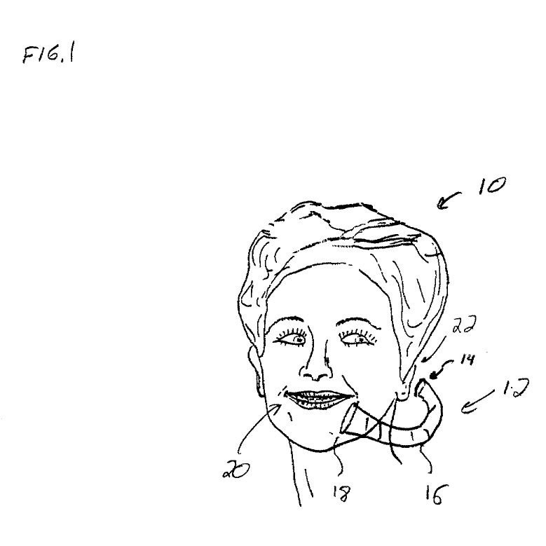

An apparatus providing immediate aural feedback to a user is disclosed. FIG. 1 is a perspective view of a user 10 and the feedback device 12 in the preferred embodiment of the present invention. The feedback device includes a receiver end 14, a main tube body 16 and a transmitter end 18 located on an opposite end from the receiver end. The transmitter end 18 is held close to a mouth 20 of the user 10. The receiver end is held close to an ear 22 of the user.

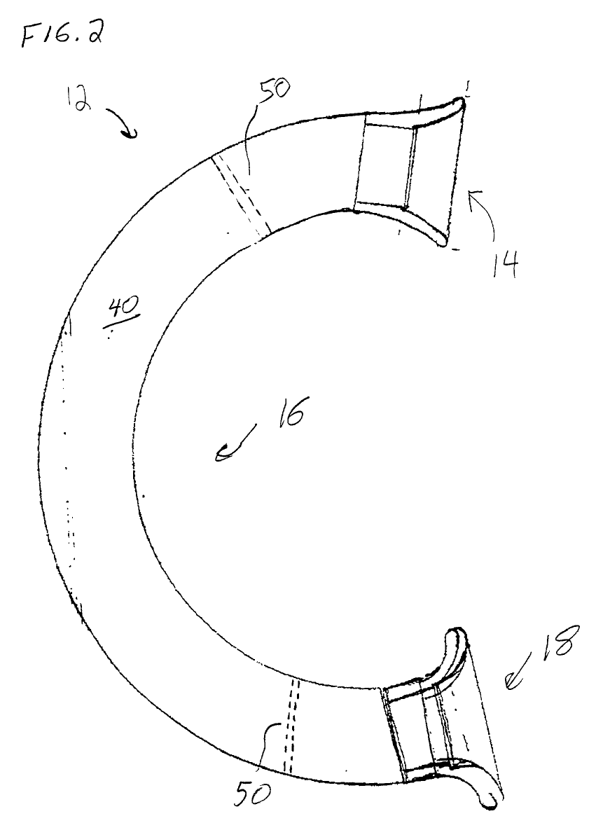

FIG. 2 is a side view of the feedback device 12 of FIG. 1. The feedback device is shaped and sized to allow the receiving end to be positioned close to the ear 22 while simultaneously allowing the transmitter end 18 to be positioned near the mouth 20 of the user. In the preferred embodiment of the present invention illustrated in FIG. 2, the shape of the feedback device 12 is “C” shaped. The transmitter end and receiver end are both angled inwardly toward the user's face. By curving the ends inwardly, the user may position the feedback device parallel to the user's face while allowing the user to comfortably and properly position the receiver end near the ear and the transmitter end near the mouth of the user. However, it must be understood, that any shape and size may be utilized which allows the simultaneous placement of the transmitter end near the mouth and the receiving end near the ear.

The main tube body is tubular in shape and hollow within the interior of the main tube body. Preferably, the main tube body is constructed of a rigid material, such as a strong rigid plastic material. However, in alternate embodiments of the present invention, the main tube body may be constructed of a flexible material allowing the receiver end 14 and the transmitter end 18 to be moved and positioned in a desired position. For example, in an alternate embodiment of the present invention, the main tube body may include segmented rings allowing the main tube to be shaped and held in a specified position.

For ease of manufacture, in the preferred embodiment of the present invention, the feedback device 12 is constructed of at least three separate pieces, the receiver end 14, the transmitter end 18, and the main tube body 16. The receiver end and the transmitter end are affixed to the main tube body. The ends may be affixed by various methods well know to those skilled in manufacturing. For example, the ends may be attached by providing threaded grooves and ridges similar to ends of a conventional telephone headset. Additionally, the ends may be affixed by adhesive glue. In an alternate embodiment of the present invention, the feedback device may be constructed of a unitary piece.

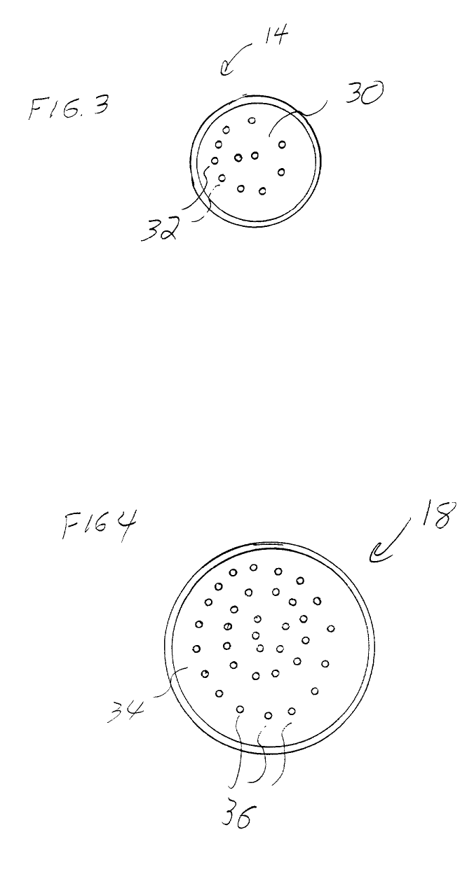

FIG. 3 is a top view of the receiver end 14 of the feedback device 12 of FIG. 1. The receiver end is preferably circular and sized to fit on an end of the main tube body 16. The receiver end preferably includes a planar cover portion 30 having a plurality of openings 32 on the planar cover portion. However, in an alternate embodiment of the present invention, the receiver end may not be used, thus providing an uncovered opening into the main tube body.

FIG. 4 is a top view of the transmitter end 18 of the feedback device 12 of FIG. 1. The transmitter end is located at an opposite end from the receiver end 14 of the feedback device. The transmitter end includes a planar surface 34 having a plurality of openings 36. In an alternate embodiment of the present invention, the transmitter end may be removed, providing a large single uncovered opening leading into the main tube body 16.

In an alternate embodiment of the present invention, the transmitter end and the receiver end may not include covers, but rather incorporate one or more rods 50 located within the interior of the main tube body. The rods are affixed to an inner wall of the main tube body and positioned to partially obstruct the interior of the main tube body. The rods may be used to prevent objects from sliding into the interior of the feedback device 12.

With reference to FIGS. 1-4, the operation of the feedback device will now be explained. When the user is speaking out loud, such as when reading or attempting to speak specific words, the user places the feedback device 12 close to his ear in a similar fashion as a telephone headset. The transmitting end is positioned close to the mouth 20 of the user and the receiver end 14 is placed near the ear 22. The user then speaks into the transmitting end. The sounds are transmitted and amplified within a hollow chamber 40 located within the interior of the main tube body. The sound is then directed toward the receiver end and the adjacently positioned ear of the user. Thus, each sound uttered by the user is amplified and immediately sent to the user's ear. By actually hearing the uttered sounds in an amplified and directed fashion immediately after being spoken, the user receives immediate feedback for all his verbalizations. Many times, the sounds the user believes he has spoken are not actually the sounds being created. By actually hearing the amplified and directed sounds, the user can correctly determine if any changes need to be made to the words being spoken.

Although the feedback device 12 illustrated is shaped similar to a phone, other shapes may be utilized and still allow the user to hear himself speak in a directed and amplified fashion. For example, the feedback device may be “J” shaped. Various sizes of the feedback device may be manufactured to accommodate various sizes of users (e.g., smaller sizes for children and larger sizes for adults). Also, the feedback device may incorporate several loops or curves within the main body tube. Additionally, the feedback device may be constructed of various colors to enhance the aesthetic appearance of the feedback device.

In an alternate embodiment of the present invention, an electronic amplifier, microphone, and receiver (not shown) may be utilized to amplified the sounds of the user and immediately direct the sounds back to the user. The microphone may be located near or at the transmitter end 18. The receiver may be located at or near the receiver end 14.

The feedback device 12 provides many advantages for the user. The feedback device provides a simple and cost-effective way of allowing a speaker to immediately hear the sounds he has uttered. With this rapid feedback, the speaker is more likely to make changes to correct any perceived deficiencies. Likewise, the feedback device provides a novel and enjoyable device for children to use while still enhancing the child's speaking and reading ability. Additionally, there is no electronic parts, thus decreasing the overall cost and maintenance of the feedback device.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A verbal feedback device for enhancing the speaking ability of a user, the device comprising:
a main hollow body;
a receiver end affixed to a first end of said main hollow body; and
a transmitter end affixed to a second opposite end of said main hollow body;
whereby the user positions said transmitter end near a mouth of the user and said receiver end near an ear of the user, the user speaks into said transmitter end sending sounds through said main body to said receiver end and to the ear of the user to provide immediate feedback of the sent sounds to the user.

2. The verbal feedback device of claim 1 wherein said main hollow body is tubular in shape.

3. The verbal feedback device of claim 1 wherein in said receiver end is curved to allow the user to position said main hollow body parallel to a face of the user while simultaneously positioning said receiver end close to the mouth of the user.

4. The verbal feedback device of claim 1 wherein said transmitter end is curved to allow the user to position said main hollow body parallel to a face of the user while simultaneously positioning said transmitter end close to the ear of the user.

5. The verbal feedback device of claim 1 wherein said receiver end includes a planar surface having a plurality of openings.

6. The verbal feedback device of claim 1 wherein said transmitter end includes a planar surface having a plurality of openings.

7. The verbal feedback device of claim 1 wherein said main hollow body is constructed of a rigid plastic material.

8. The verbal feedback device of claim 1 wherein the sent sounds are amplified within main hollow body.

9. The verbal feedback device of claim 1 wherein:
said receiver end is curved; and
said transmitter end is curved;
said transmitter end and receiver end being affixed to said main hollow body providing a C-shaped configuration;
whereby the user may position said main hollow body parallel to a face of the user and comfortably position the receiver end near the ear and the transmitter end near the mouth.

10. A verbal feedback device for enhancing the speaking ability of a user, the device comprising:
a main hollow body;
a curved receiver end affixed to a first end of said main hollow body, said receiver end having a first planar surface having a first plurality of openings; and
a curved transmitter end affixed to a second opposite end of said main hollow body, said transmitter end having a second planar surface having a second plurality of openings;
whereby the user positions said main hollow body parallel to a face of the user, said transmitter end near a mouth of the user and said receiver end near an ear of the user, the user speaking into said transmitter end sending sounds through said main body to said receiver end and to the ear of the user to provide immediate feedback of the sent sounds to the user.

11. A verbal feedback device for enhancing the speaking ability of a user, the device comprising:
a main tubular body having a hollow chamber;
a receiver end affixed to a first end of said main hollow body; and
a transmitter end affixed to a second opposite end of said main hollow body;
whereby the user positions said transmitter end near a mouth of the user and said receiver end near an ear of the user, the user speaks into said transmitter end sending sounds through said main body into the hollow chamber, the hollow chamber amplifying the sent sounds and directing the sounds to said receiver end and to the ear of the user to provide immediate feedback of the sent sounds to the user.
